(19) United States
(12) Patent Application Publication
(10) Pub. No.: US 2016/0195250 A1
(43) Pub. Date: Jul. 7, 2016

(54) LINE TYPE LIGHTING APPARATUS

(71) Applicants: Hyun Yong PARK, Seoul (KR); Byung Kwon SUNG, Seoul (KR); LINNO., LTD., Namyangju-si (KR)

(72) Inventor: Hyun Yong PARK, Seoul (KR)

(21) Appl. No.: 14/984,243

(22) Filed: Dec. 30, 2015

(30) Foreign Application Priority Data
Jan. 5, 2015 (KR) 10-2015-0000812

(51) Int. Cl. F21V 21/005; F21S 8/00; F21V 3/04; F21V 21/35

(52) U.S. Cl. CPC F21V 21/005; F21V 21/35; F21S 8/038; F21V 3/049; F21Y 2101/02

(57) ABSTRACT

Provided herein is a line type lighting apparatus comprising: a line type lighting module having a power connecting plug formed on at least one surface of the module; and a track housing including a plurality of frames which are provided with accommodating space to which the lighting module may be coupled and which are connected in a longitudinal direction, a power plug for supplying power arranged in a position corresponding to the connecting plug of the lighting module in a longitudinal direction within the accommodating space, an insulating member which surrounds the power plug, and an opening groove which is formed on a surface facing the connecting plug of the lighting module in a longitudinal direction and which exposes the power plug, wherein the track housing includes an insertion groove which is formed at an end of at least one frame of one pair of frames adjacent to each other and which exposes the power plug, and a connecting piece configured to be inserted into the insertion groove and to electrically connect the power plugs of the one pair of frames.

### CROSS-REFERENCE TO RELATED APPLICATION

This application claims the benefit of priority under 35 U.S.C. §119(a) of Korean Patent Application No. 10-2015-0000812, filed on Jan. 5, 2015, in the Korean Intellectual Property Office, the entire disclosure of which is incorporated herein by reference for all purposes.

### BACKGROUND

1. Field

The following description relates to a line type lighting apparatus, and more particularly to a line type lighting apparatus wherein line type lighting modules may slide freely along a plurality of frames connected in a longitudinal direction.

2. Description of Related Art

A fluorescent lamp generally used for lighting has a disadvantage of low illumination intensity and low energy efficiency, and thus in recently days, lighting modules that utilize light emitting diodes (hereinafter referred to as “LED”) providing greater illumination but consuming less power are being widely used.

Therefore, a lot of researches are being made in order to replace conventional light sources with LED lamps that are increasingly being used as the light source for lighting apparatuses such as various types of lamps, liquid crystal display devices, electronic displays, streetlights and the like.

Especially, the recent growing need for sophisticated line type designs expanded the markets for line type lighting apparatuses, and therefore various types of bar type line lighting apparatuses are being developed.

However, such a conventional line type lighting apparatus is generally fixedly installed onto a subject area by connecting a plurality of bar type lighting modules in series, and thus leads to problems of too much time and cost for installing the entire lighting system, and difficulty in separating or moving the lighting modules.

Furthermore, a line type lighting apparatus such as Korean Patent No. 1351358 was developed wherein a plurality of line type lighting modules are coupled to a plurality of track housings to be supplied with power, and wherein the lighting modules are configured to slide along a longitudinal direction of the track housings so that the lighting modules can be easily moved, repaired, and maintained.

However, such a conventional line type lighting apparatus is provided with a connector for electrically connecting a power plug of track housing at both sides, thereby limiting the movement range of the lighting modules to the area between both connectors, which is a problem.

### PRIOR ART DOCUMENT

[Patent 1] Korean Patent No. 1351358 (Jan. 23, 2014)

All documents cited in the present disclosure, including published documents, patent applications, and patents, may be incorporated herein in their entirety by reference in the same manner as when each cited document is separately and specifically incorporated or incorporated in its entirety.

### SUMMARY

This summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

A purpose of the present disclosure is to resolve the problems of prior art, that is to provide a line type lighting apparatus wherein line type lighting modules may slide freely along a plurality of frames connected in a longitudinal direction.

Another purpose of the present disclosure is to provide a line type lighting apparatus wherein a plurality of frames constituting a track housing may be easily connected.

According to an aspect, there is provided a line type lighting apparatus comprising: a line type lighting module having a power connecting plug formed on at least one surface of the module; and a track housing including a plurality of frames which are provided with accommodating space to which the lighting module may be coupled and which are connected in a longitudinal direction, a power plug for supplying power arranged in a position corresponding to the connecting plug of the lighting module in a longitudinal direction within the accommodating space, an insulating member which surrounds the power plug, and an opening groove which is formed on a surface facing the connecting plug of the lighting module in a longitudinal direction and which exposes the power plug, wherein the track housing includes an insertion groove which is formed at an end of at least one frame of one pair of frames adjacent to each other and which exposes the power plug, and a connecting piece configured to be inserted into the insertion groove and to electrically connect the power plugs of the one pair of frames.

Herein, the insertion groove may be formed on a second surface of the power plug that is adjacent to or opposite to a first surface of the power plug exposed through the opening groove.

Furthermore, the insertion groove may be formed on each end of the one pair of frames adjacent to each other, and each of both ends of the connecting piece may be inserted into the insertion groove of the one pair of frames adjacent to each other so as to electrically connect the power plugs of the one pair of frames.

Furthermore, a connecting bump may be formed in a protruding manner on at least one of the contact surfaces of the connecting piece and the power plug.

Furthermore, the connecting bump may be elastically supported in a protruding direction.

Furthermore, a protruding boss configured to closely contact an end of the power plug may be formed on the connecting piece.

Furthermore, the track housing may further include an insulated insertion member arranged on at least one of the ends of the one pair of frames adjacent to each other to surround the power plug.

Furthermore, a connecting groove configured to expose the power plug may be formed on a position of the insulated insertion member corresponding to the opening groove in a longitudinal direction.

Furthermore, an accommodating groove configured to accommodate the power plug may be formed at one end of the insulated insertion member, and the insertion groove may be formed at the other end of the insulted insertion member.

Furthermore, a stopper configured to guide an insertion position of the power plug or the insertion piece may be formed on an inner end of at least one of the accommodating groove and the insertion groove.

Furthermore, the insulated insertion member may be arranged at each end of one pair of frames adjacent to each other, and the connecting piece may be inserted into the insertion groove of the insulated insertion members adjacent to each other to electrically connect the power plugs of the one pair of frames.

Furthermore, a connecting bump may be formed on at least one of the contact surfaces of the connecting piece and the power plug in a protruding manner.

Furthermore, the connecting bump may be elastically supported in a protruding direction.

According to the present disclosure, there is provided a line type lighting apparatus wherein line type lighting modules may slide freely along a plurality of frames connected in a longitudinal direction.

Furthermore, there is provided a line type lighting apparatus wherein a plurality of frames constituting a track housing may be easily connected.

Other features and aspects will be apparent from the following detailed description, the drawings, and the claims.

### BRIEF DESCRIPTION OF THE DRAWINGS

FIG. 1 is a perspective view of a line type lighting apparatus according to a first embodiment of the present disclosure;

FIG. 2 is an exploded perspective view of a track housing of a line type lighting apparatus according to the first embodiment of the present disclosure:

FIG. 3 is a cross-sectional view of a main configuration of a line type lighting apparatus according to the first embodiment of the present disclosure;

FIG. 4 is a cross-sectional view cut along line A-A′ of FIG. 3;

FIG. 5 is a cross-sectional view cut along line B-B′ of FIG. 3;

FIG. 6 is an exploded perspective view of a track housing of a line type lighting apparatus according to a second embodiment of the present disclosure;

FIGS. 7 to 8 are cross-sectional views of a main configuration of a line type lighting apparatus according to a second embodiment of the present disclosure; and

FIG. 9 is a cross-sectional view of a line type lighting apparatus according to a third embodiment of the present disclosure.

### DETAILED DESCRIPTION

Components that are configured the same in various embodiments will be explained with reference to the first embodiment using the same reference numerals, and only the components that are configured differently will be explained with reference to other embodiments.

Hereinafter, a line type lighting apparatus according to the first embodiment of the present disclosure will be explained in detail with reference to the attached drawings.

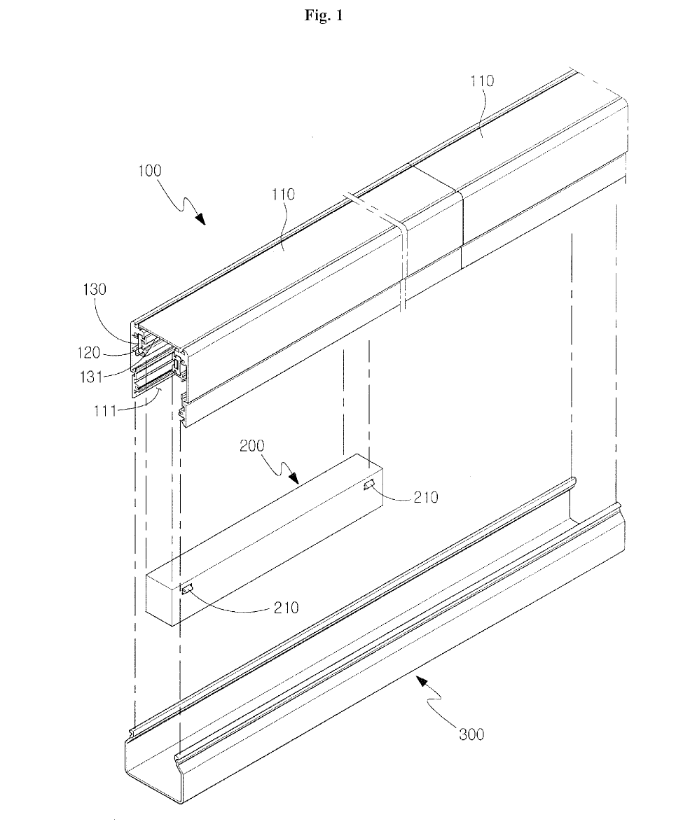

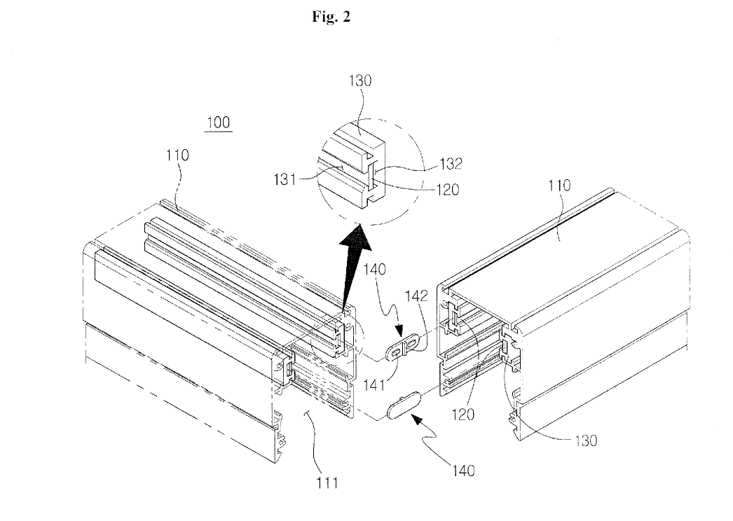

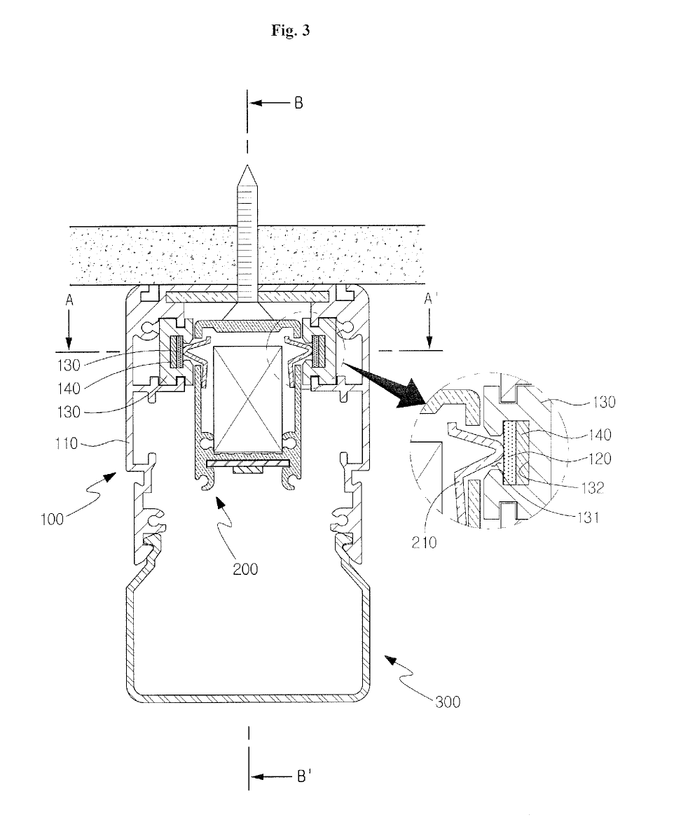

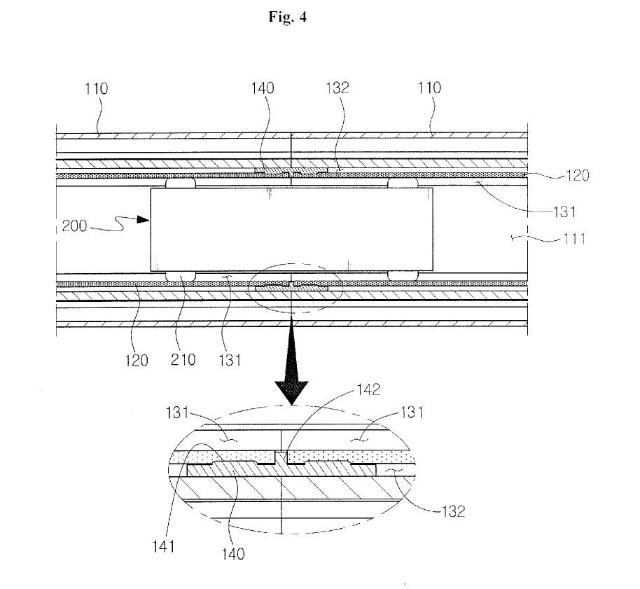

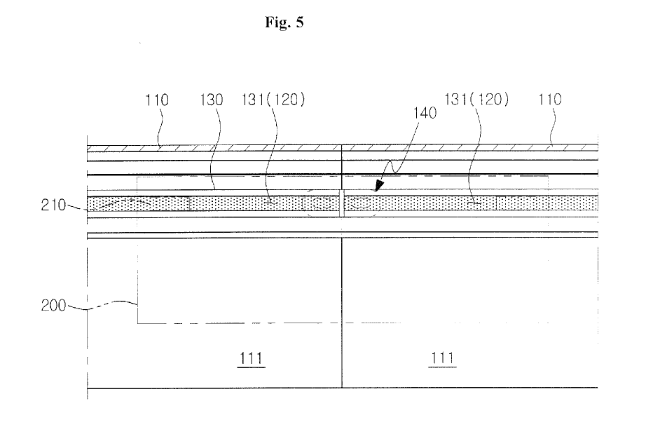

FIG. 1 is a perspective view of a line type lighting apparatus according to the present disclosure and FIG. 2 is an exploded perspective view of a track housing of a line type lighting apparatus of the present disclosure.

As illustrated in the drawings, the present disclosure includes a line type lighting module 200; and a track housing 100 configured to supply power to the line type lighting module 200 and to allow the line type lighting module 200 to slide in a longitudinal direction.

The line type lighting module 200 is configured to be coupled to the track housing 100 in a detachable manner and to receive power and provide light. On a lower portion of the lighting module 200, a plurality of lighting emitting elements (not illustrated) are arranged in a longitudinal direction, and at both sides of the lighting module, a connecting plug 210 electrically connected to the light emitting element is formed in a protruding manner. The connecting plug 210 is configured in the form of a plate spring so that it may be elastically supported in a protruding direction from a main body.

Furthermore, inside the lighting module 200, a power supply apparatus (SMPS; Switching Mode Power Supply) may be embedded that is configured to stably supply power being applied through the power plug 120.

The track housing 100 may be installed on a subject surface in various formats such as by being fixed, embedded or suspended. The track housing 100 includes a frame 110 having an open lower portion and an accommodating space 111 to which the lighting module 200 may be coupled; a power plug 120 arranged in a position corresponding to the connecting plug 210 of the lighting module 200; an insulating member 130 configured to surround the power plug 120 and to be fixed to the frame 110; and an opening groove 131 formed on a surface of the insulating member that faces the connecting plug 210 of the lighting module 200 in a longitudinal direction such that it exposes a first surface of the power plug 120. The frame 110 may be made of a light metal material such as aluminum for structural rigidity and light weight. Furthermore, on the insulating member 130 positioned at an end of the frame 110, an insertion groove 132 is formed that exposes a second surface that is adjacent to or is at an opposite side of the first surface of the power plug 120.

The track housing 100 may be extended to a desired length by connecting a plurality of frames 110 in a line, and for this purpose, a connecting piece 140 for electrically connecting power plugs 120 of one pair of frames 110 that are adjacent to each other may be included. On a surface of the connecting piece 140 facing the power plug 120, a connecting bump 141 is formed for a stable connection with the power plug 120, and at a center of the surface of the connecting piece 140 facing the power plug 120, a protruding boss 142 for fixating the position of the connecting piece 140 between the power plugs 120 is formed in a protruding manner. Meanwhile, the connecting bump 141 may have a rear end connected to the connecting piece 140 and a front end configured as an elastic body that protrudes in an inclined direction towards the power plug 120.

Meanwhile, at the opening of the track housing 100, a diffusion cover 300 made of a transparent material may be arranged, thereby finishing the accommodating space 110 while at the same time softly diffusing LED light being provided from the line type lighting module 200.

According to the present disclosure as aforementioned, it is possible to configure the track housing 100 in a desired length by connecting and installing a plurality of frames 110 on a subject surface, and arrange the connecting piece 140 at connecting areas of the plurality of frames 110, thereby electrically connecting the power plugs 120 of the frames 110.

The first surface of the power plug 120 is exposed to the accommodating space 111 through the opening groove 131, and the second surface that is adjacent to or at an opposite side of the first surface is exposed through the insertion groove 132. Therefore, both ends of the connecting piece 140 may each be inserted into the insertion groove 132 of one pair of frames 110 adjacent to each other to be connected to the second surface of the power terminals 120, thereby electrically connecting the power plugs 120 of the frames. Herein, the connecting bump 141 formed at both ends of the connecting piece 140 are connected to the power plugs 120 of the frames 110, respectively, and the protruding boss 142 formed at a center of the connecting piece 140 is placed between the ends of the power plugs 120, and therefore the position of the connecting piece is fixated. Especially, since the first surface of the power plug 120 is exposed along the longitudinal direction through the opening groove 131 of the insulating member 130 that surrounds the power plug 120, with the connecting plug 210 of the lighting module 200 connected to the first surface of the power plug 120, the lighting module 200 may slide along the opening groove 131.

In response to the lighting module 200 being pushed into the accommodating space 111 inside the track housing 100, the front end of the connecting plug 210 will be connected to the first surface of the power plug 120 through the opening groove 131 of the insulating member 130 that will be explained hereinafter, and at the same time the connecting plug 210 and opening groove 131 will engage each other, thereby preventing the lighting module 200 from deviating away from the track housing 100, and thus the state of the lighting module 200 being coupled within the accommodating space 111 of the track housing 100 is maintained. Meanwhile, in response to the lighting module 200 inside the accommodating space 111 being pulled towards the opening side by a force greater than the elastic force of the connecting plug 210, the connecting plug 210 will deviate from the opening groove 131, and thus it will be possible to easily separate the lighting module 200 from the track housing 100.

Furthermore, since the connecting plug 210 of the lighting module 200 is elastically supported towards the power plug 120 while it is being connected to the power plug 120 through the opening groove 131, the connecting plug 210 of the lighting module 200 may slide along the longitudinal direction of the frame 110 along the opening groove 131.

Especially, in the case of the power plug 120, since the power plugs 120 of the frames 110 are electrically connected by the connecting piece 140 arranged on the second surface, the continuity of the first surface of the power plug 120 and the opening groove 131 of the insulating member 130 will be maintained at the connecting area of the one pair of frames 110 adjacent to each other. Therefore, since the connecting plug 210 of the lighting module 200 may slide along the opening groove 131 even at the connecting area of the one pair of frames adjacent to each other, the lighting module 200 also becomes able to slide freely along the plurality of frames 110 connected in the longitudinal direction.

Hereinafter, a line type lighting apparatus according to the second embodiment of the present disclosure will be explained.

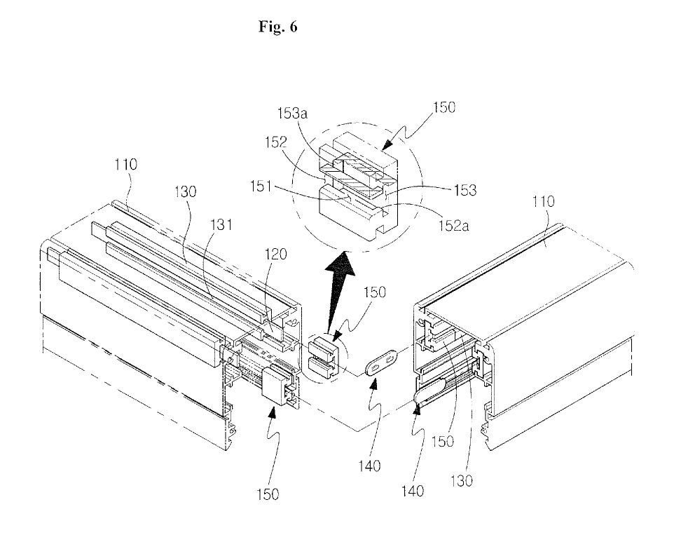

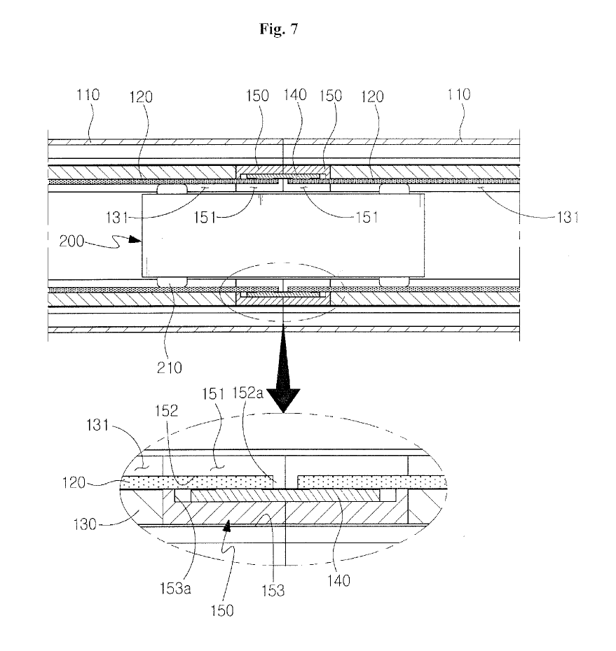

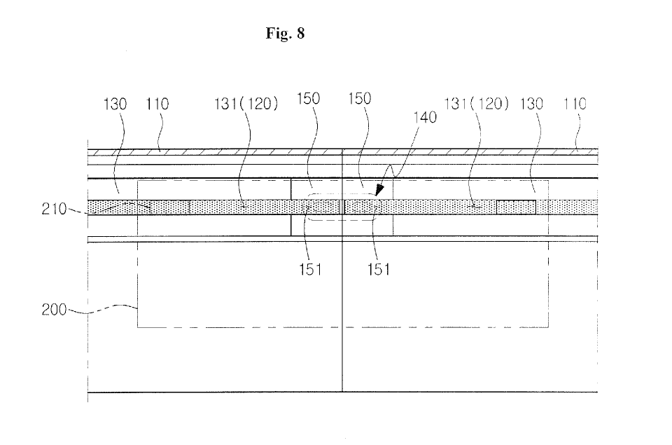

FIG. 6 is an exploded perspective view of a track housing of a line type lighting apparatus according to the second embodiment of the present disclosure; and FIGS. 7 to 8 are cross-sectional views of a main configuration of a line type lighting apparatus according to the second embodiment of the present disclosure.

As illustrated in these drawings, the line type lighting apparatus according to the second embodiment of the present disclosure is different from the configuration of the first embodiment in that an insulated insertion member 150 having an insertion groove 153 is arranged in a line with the insulating member 130 at an end of the frame 110.

At each end of the plurality of frames 110 constituting the track housing 100, an insertion space is arranged for insertion of the insulated insertion member 150, and the power plug 120 protrudes from the end of the insulating member 130 such that it may be placed inside the insertion space.

The insulated insertion member 150 is made of an insulating material and is configured to be inserted into the insertion space of the end of the frame 110. At one end of the insulated insertion member that faces the insulating member 130, an accommodating groove 152 into which the power plug 120 may be inserted is formed, and at the other end, an insertion groove 153 into which the connecting piece 140 may be inserted is formed. At each inner end of the accommodating groove 152 and insertion groove 153, stoppers 152a, 153a are formed respectively, so as to guide the insertion position of the power plug 120 or the connecting piece 140. Especially, in the insulated insertion member 150, a connecting groove 151 configured to expose the power plug 120 is formed in a longitudinal direction at a position corresponding to the opening groove 131.

In the line type lighting apparatus according to the second embodiment of the present disclosure configured as aforementioned, when the insulated insertion member 150 is inserted into each end of the one pair of frames 110 adjacent to each other, and the connecting piece 140 is inserted into the insertion groove 153 of the insulated insertion members 150, both ends of the connecting piece 140 will each be connected to the power plug 120 exposed through the insertion groove 153, thereby electrically connecting the power plugs 120 of the frames 110.

Herein, the opening groove 131 of the insulating member 130 constituting the movement path of the connecting plug 210 of the lighting module 200 maintains its continuity at a connecting area of the frames 110 by the connecting groove 151 of the insulated insertion member 150, and therefore the lighting module 200 becomes able to slide freely along the plurality of frames 110 connected in a longitudinal direction.

When a separate insulated insertion member 150 is provided to form an insertion groove 153, the insulating member 130 will surround the power plug 120 at a remaining area besides the opening groove 131, thereby stably supporting the power plug 120.

Meanwhile, it was explained that in the present embodiment, one pair of insulated insertion members 150 are each inserted into each end of the frame 110 of both sides, and both ends of the connecting piece 140 are inserted into the insertion groove 153 of the insulated insertion members 150, thereby connecting the power plug 120 of the frames 110, but it is also possible to provide the one pair of insulated insertion members 150 in an integrated form, and to insert both ends of the insulated insertion member 150 into the insertion space of the frames 110 with the connecting piece 140 inserted into the insulated insertion member 150, thereby electrically connecting the power plugs 120.

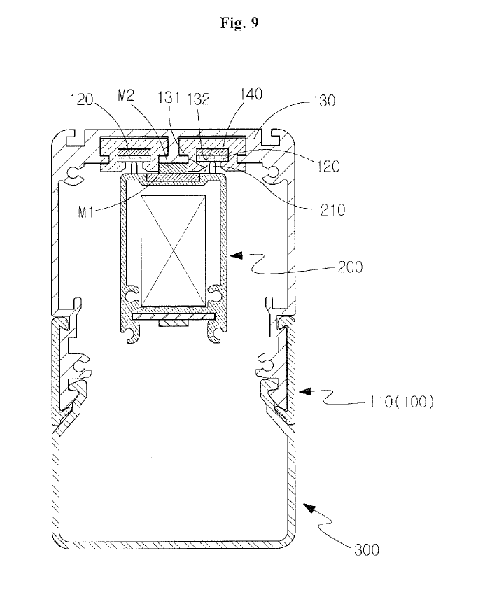

FIG. 9 is a cross-sectional view of a line type lighting apparatus according to the third embodiment of the present disclosure.

It was explained with reference to the first embodiment and second embodiment that the connecting plug 210 of the lighting module 200 is arranged at both sides, and the power plug 120 corresponding to the connecting plug 210 is arranged at both sides of the accommodating space 111 of the track housing 100, but as illustrated in FIG. 9, it is possible to form the connecting plug 210 on an upper surface of the lighting module 200, arrange the power plug 120, the insulating member 130 and the opening groove 131 on an upper surface inside the accommodating space 111 of the track housing 100 facing the upper surface of the lighting module 200 in a longitudinal direction, and arrange the insertion groove 132 and the connecting piece 140 on the second surface of the power plug 120.

Furthermore, it was explained with reference to the first embodiment and second embodiment, that the coupling of the lighting module 200 and track housing 100 is made by the coupling of the connecting plug 210 and opening groove 131, but it is also possible to arrange one pair of permanent magnets having mutual attraction force each on a surface of the light module 200 and the track housing 100 facing each other, or arrange a permanent magnet M1 and a metal plate M2 to which the permanent magnet sticks to by magnetism, so that the lighting module 200 may be coupled to the track housing 100 by the magnetism of the permanent magnet.

The scope of rights of the present disclosure is not defined by the aforementioned embodiments but in variety of formats within the scope of the claims attached hereto and their equivalents. It will be apparent to one of ordinary skill in the art that various changes in form and details may be made in these examples without departing from the spirit and scope of the claims and their equivalents

### REFERENCE NUMERALS

100: TRACK HOUSING
110: FRAME
111: ACCOMMODATING SPACE
120: POWER PLUG
130: INSULATING MEMBER
131: OPENING GROOVE
132: INSERTION GROOVE
140: CONNECTING PIECE
141: CONNECTING BUMP
142: PROTRUDING BOSS
150: INSULATED INSERTION MEMBER
151: CONNECTING GROOVE
152: ACCOMMODATING GROOVE
152A: STOPPER
153: INSERTION GROOVE
153A: STOPPER
200: LIGHTING MODULE
21: CONNECTING PLUG
300: DIFFUSION COVER

What is claimed is:

1. A line type lighting apparatus comprising:
a line type lighting module having a power connecting plug formed on at least one surface of the module; and
a track housing including a plurality of frames which are provided with accommodating space to which the lighting module may be coupled and which are connected in a longitudinal direction, a power plug for supplying power arranged in a position corresponding to the connecting plug of the lighting module in a longitudinal direction within the accommodating space, an insulating member which surrounds the power plug, and an opening groove which is formed on a surface facing the connecting plug of the lighting module in a longitudinal direction and which exposes the power plug,
wherein the track housing includes an insertion groove which is formed at an end of at least one frame of one pair of frames adjacent to each other and which exposes the power plug, and a connecting piece configured to be inserted into the insertion groove and to electrically connect the power plugs of the one pair of frames.

2. The line type lighting apparatus according to claim 1,
wherein the insertion groove is formed on a second surface of the power plug that is adjacent to or opposite to a first surface of the power plug exposed through the opening groove.

3. The line type lighting apparatus according to claim 1,
wherein the insertion groove is formed on each end of the one pair of frames adjacent to each other, and
each of both ends of the connecting piece is inserted into the insertion groove of the one pair of frames adjacent to each other so as to electrically connect the power plugs of the one pair of frames.

4. The line type lighting apparatus according to claim 3,
wherein a connecting bump is formed in a protruding manner on at least one of the contact surfaces of the connecting piece and the power plug.

5. The line type lighting apparatus according to claim 4,
wherein the connecting bump is elastically supported in a protruding direction.

6. The line type lighting apparatus according to claim 3,
wherein a protruding boss configured to closely contact an end of the power plug is formed on the connecting piece.

7. The line type lighting apparatus according to claim 1,
wherein the track housing further comprises an insulated insertion member arranged on at least one of the ends of the one pair of frames adjacent to each other to surround the power plug.

8. The line type lighting apparatus according to claim 7,
wherein a connecting groove configured to expose the power plug is formed on a position of the insulated insertion member corresponding to the opening groove in a longitudinal direction.

9. The line type lighting apparatus according to claim 8,
wherein an accommodating groove configured to accommodate the power plug is formed at one end of the insulated insertion member, and the insertion groove is formed at the other end of the insulted insertion member.

10. The line type lighting apparatus according to claim 9,
wherein a stopper configured to guide an insertion position of the power plug or the insertion piece is formed on an inner end of at least one of the accommodating groove and the insertion groove.

11. The line type lighting apparatus according to claim 9,
wherein the insulated insertion member is arranged at each end of one pair of frames adjacent to each other, and
wherein the connecting piece is inserted into the insertion groove of the insulated insertion members adjacent to each other to electrically connect the power plugs of the one pair of frames.

12. The line type lighting apparatus according to claim 11,
wherein a connecting bump is formed on at least one of the contact surfaces of the connecting piece and the power plug in a protruding manner.

13. The line type lighting apparatus according to claim 12,
wherein the connecting bump is elastically supported in a protruding direction.
